(19) United States
(12) Patent Application Publication
(10) Pub. No.: US 2016/0249421 A1
(43) Pub. Date: Aug. 25, 2016

(54) BACKLIGHT MODULE FOR LIQUID CRYSTAL DISPLAY AND LIQUID CRYSTAL DISPLAY DEVICE

(71) Applicant: Shenzhen China Star Optoelectronics Technology Co., Ltd., Shenzhen, Guangdong (CN)

(72) Inventor: Yingbo Zheng, Shenzhen, Guangdong (CN)

(73) Assignee: Shenzhen China Star Optoelectronics Technology Co., Ltd., Shenzhen, Guangdong (CN)

(21) Appl. No.: 14/418,621

(22) PCT Filed: Jan. 21, 2015
(86) PCT No.: PCT/CN2015/071212

§ 371 Date: May 10, 2016

(30) Foreign Application Priority Data
Dec. 31, 2014 (CN) 201410856635.1

(51) Int. Cl. H05B 33/08; F21V 8/00

(52) U.S. Cl. CPC H05B 33/0815; G02B 6/0045; G02B 6/0068

(57) ABSTRACT

A backlight module for liquid crystal display device and a liquid crystal display device are disclosed. The backlight module comprises a light source circuit and a light guide plate, wherein said light source circuit comprises a control circuit and a plurality of light-emitting units, which are arranged on a lateral surface of said light guide plate and connected with said control circuit, each light-emitting unit being activated or deactivated by said control circuit; and wherein said light guide plate is used for guiding light which enters from the lateral surface, so that the light exits from a front surface. The power consumption of the backlight module according to the present disclosure is lower than the light source circuit of the backlight module in the prior art.

### CROSS REFERENCE TO RELATED APPLICATION

The present application claims benefit of Chinese patent application CN 201410856635.1, entitled “Backlight Module for Liquid Crystal Display and Liquid Crystal Display Device” and filed on Dec. 31, 2014, which is incorporated herein by reference.

### FIELD OF THE INVENTION

The present disclosure relates to the technical field of liquid crystal display, and particularly to a backlight module for liquid crystal display device and a liquid crystal display device.

### BACKGROUND OF THE INVENTION

With the development of mobile technology, mobile phones have become indispensable communication tools in people's daily life. At present, Liquid Crystal Display (LCD) devices are most widely used as the screens of mobile phones. The liquid crystal display technology has undergone the development from black-and-white screen to colored screen, as well as from Twisted Nematic LCD (TN-LCD) to Thin Film Transistor LCD (TFT-LCD).

With the development of liquid crystal display technology, the size of the liquid crystal display devices that are used in mobile phones is becoming increasingly large, which renders that the power consumption of the liquid crystal display devices is becoming increasingly high. The backlight module is the main power consuming unit in the liquid crystal display device. FIG. 1 schematically shows a light source circuit of the backlight module in the prior art. As shown in FIG. 1, the light source circuit in the prior art consists of multiple light-emitting diode circuits that are in parallel connection with one another, and each light-emitting diode circuit consists of a plurality of light-emitting diodes that are in series connection with one another. The structure of the light source circuit renders that the light-emitting diodes in the light source circuit are all activated when the liquid crystal display device of the mobile phone is in operation, no matter how the bright-dark distribution of the images displayed therein and the requirement thereof change. That is, the power consumption of the light-emitting circuit is maintained at 100 percent all the time.

The structure of the backlight module in the prior art renders that the power consumption of the liquid crystal display screen accounts for 60 percent to 70 percent of the power consumption of the whole mobile phone. Since the limitation of the battery capacity of the mobile phone, the standby time thereof is greatly shortened due to the high power consumption of the liquid crystal display screen.

Therefore, a backlight module for liquid crystal display device with low power consumption is urgently needed.

### SUMMARY OF THE INVENTION

The present disclosure aims to solve the technical problem of high power consumption of the backlight module of the liquid crystal display device in the prior art. In order to solve the aforesaid technical problem, the embodiment of the present disclosure firstly provides a backlight module for liquid crystal display device, comprising a light source circuit and a light guide plate. Said light source circuit comprises a control circuit, and a plurality of light-emitting units that are arranged on a lateral surface of said light guide plate and connected with said control circuit, each light-emitting unit being activated or deactivated by said control circuit. Said light guide plate is used for guiding light which enters from the lateral surface, so that the light exits from a front surface.

According to one embodiment of the present disclosure, a first end of each light-emitting unit is connected with a first end of a preset power source, and a second end thereof is connected with a corresponding end of said control circuit.

According to one embodiment of the present disclosure, each light-emitting unit comprises a light-emitting diode, a positive pole of said light-emitting diode being connected with the first end of the preset power source, and a negative pole thereof being connected with a corresponding end of said control circuit.

According to one embodiment of the present disclosure, said control circuit comprises a controllable switch, a first end of said controllable switch being connected with a second end of said preset power source, and each second end thereof being connected with a second end of a corresponding light-emitting unit respectively.

According to one embodiment of the present disclosure, said control circuit controls a time period during which said light-emitting unit is activated or deactivated through regulating a duty ratio of a control signal, so that brightness of said light-emitting unit is regulated.

According to one embodiment of the present disclosure, said light guide plate comprises a first surface and a second surface in parallel with each other, said first surface being provided with cylindrical protrusions that are parallel with one another, and said cylindrical protrusions or said second surface being provided with light guide apertures.

According to one embodiment of the present disclosure, said light guide plate comprises a first surface and a second surface in parallel with each other, said first surface and said second surface each being provided with cylindrical protrusions that are parallel with one another, and the cylindrical protrusions that are arranged on said first surface or said second surface being provided with light guide apertures.

According to one embodiment of the present disclosure, said light guide apertures are arranged along an axial direction of said cylindrical protrusions in a non-uniform manner.

According to one embodiment of the present disclosure, a space between two adjacent light guide apertures that are arranged in one cylindrical protrusion becomes nearer when a distance thereof from a first end of said cylindrical protrusion gets farther.

The present disclosure further provides a liquid crystal display device, which comprises a backlight module for liquid crystal display device as mentioned in any one of the above items.

Compared with the light source circuit of the backlight module in the prior art, in the light source circuit of the backlight module according to the present disclosure, the light-emitting units can be controlled separately. In this case, when it is not necessary to activate all light-emitting units according to actual needs of the liquid crystal display device, the light-emitting units which are necessary can be activated by the control circuit, while the light-emitting units which are not necessary can be deactivated by the control circuit. Since it is not necessary to activate all light-emitting units, the power consumption of the backlight module can be reduced effectively, and thus the life time of the electric devices (such as mobile phones) can be prolonged.

In addition, in the light source circuit according to the present disclosure, the brightness of the light source can also be regulated. Specifically, the time period during which the controllable switch is turned on or turned off can be regulated through regulating the duty ratio of the control signal, so that the time period during which the light-emitting diode is activated or deactivated can be regulated. During a certain time period, the longer the time during which the light-emitting diode is activated is, the brighter the light source looks; on the contrary, during a certain time period, the shorter the time during which the light-emitting diode is activated is, the darker the light source looks. In this manner, the brightness of the light source can be regulated.

According to the present disclosure, the surface of the light guide plate is provided with cylindrical protrusions that are parallel with one another, which enable the light to be in a relatively convergent state when transmitting in the light guide plate. Therefore, compared with the light guide plate in the prior art, the light guide plate provided by the present disclosure has a better light converging effect. Thus, the crosstalk of the light in the light guide plate can be reduced significantly.

In the light guide plate provided by the present disclosure, the light guide apertures are arranged in a non-uniform manner in order to guarantee the uniformity of the light that exits from the surface of the light guide plate. Specifically, in each cylindrical protrusion that is provided with light guide apertures, a space between two adjacent light guide apertures that are arranged in the cylindrical protrusion becomes nearer (i.e., the light guide apertures are distributed in a denser manner) when a distance between the light guide apertures and a first end of the cylindrical protrusion (i.e., the end near to the light-emitting units) gets farther.

The light that exits from the light guide apertures near to the light-emitting units is relatively more, but the light guide apertures are distributed in a sparse manner at this region. By contrast, the light that exits from the light guide apertures far from the light-emitting units is relatively less, but the light guide apertures are distributed in a dense manner at this region. In this manner, the light that exits from each region of the light guide plate can be kept balanced, and thus the uniformity of the light that exits from the surface of the light guide plate can be ensured.

Other features and advantages of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The drawings necessary for explaining the embodiments or the prior art are introduced briefly below to illustrate the technical solutions of the embodiments of the present disclosure or the prior art more clearly.

FIG. 1 schematically shows a light source circuit of a backlight module of a liquid crystal display panel in the prior art;

FIG. 2 schematically shows a light source circuit of a backlight module according to one embodiment of the present disclosure;

FIG. 3a is a structural diagram of the backlight module in the prior art;

FIG. 3b schematically shows a light path in a light guide plate in the prior art;

FIG. 4 and FIG. 5 are a front view and a top view of a light guide plate respectively according to one embodiment of the present disclosure;

FIG. 6 schematically shows a device for manufacturing a light guide plate according to one embodiment of the present disclosure;

FIG. 7 schematically shows a structure of a backlight module according to one embodiment of the present disclosure;

FIG. 8 schematically shows a light path in the light guide plate when one light-emitting unit is activated according to one embodiment of the present disclosure;

FIG. 9 schematically shows a light path in the light guide plate when multiple light-emitting units are activated according to one embodiment of the present disclosure;

FIG. 10 schematically shows a light path in the light guide plate according to one embodiment of the present disclosure;

FIG. 11 schematically shows an arrangement of light guide apertures in the light guide plate according to one embodiment of the present disclosure;

FIG. 12 and FIG. 13 are a front view and a top view of a light guide plate respectively according to another embodiment of the present disclosure;

FIG. 14 schematically shows a structure of a light guide plate according to a further embodiment of the present disclosure; and

FIG. 15 schematically shows a structure of a light guide plate according to a still further embodiment of the present disclosure.

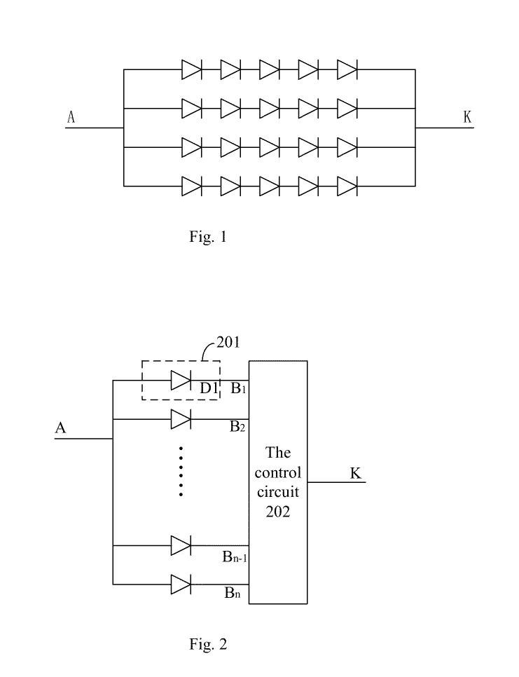

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It should be noted that, as long as there is no structural conflict, all the technical features mentioned in all the embodiments may be combined together in any manner, and the technical solutions obtained in this manner all fall within the scope of the present disclosure.

Many specific details are illustrated hereinafter for providing a thorough understanding of the embodiments of the present disclosure. However, it is obvious for those skilled in the art that, the present disclosure can be implemented in other methods in addition to the details or specifics described herein.

In order to solve the technical problem of high power consumption of the backlight module of the liquid crystal display device in the prior art, the present embodiment provides a backlight module of a liquid crystal display device, in which each light-emitting unit can be activated or deactivated separately. The backlight module comprises a light source circuit and a light guide plate.

FIG. 2 schematically shows the light source circuit of the backlight module.

As shown in FIG. 2, the light source circuit provided by the present embodiment comprises a control circuit 202 and a plurality of light-emitting units 201. Each light-emitting unit 201 is connected with a corresponding end of the control circuit 202, so that it can be activated or deactivated by the control circuit 202. According to the present embodiment, the light-emitting units are arranged on a lateral surface of the light guide plate to serve as side light sources thereof. The light guide plate can guide the light which enters from the lateral surface, so that the light exits from a front surface, i.e., the side light sources can be converted into surface light sources.

According to the present embodiment, a first end of each light-emitting unit 201 is connected with a first end of a preset power source, and a second end thereof is connected with a corresponding end of the control circuit 202. As shown in FIG. 2, in the backlight module provided by the present embodiment, a light-emitting diode is used to serve as the light-emitting unit. A positive pole of the light-emitting diode is connected with the first end of the preset power source (the positive pole of the preset power source, i.e., the end A), and a negative pole thereof is connected with a corresponding end of the control circuit 202.

According to the present embodiment, the control circuit 202 comprises a controllable switch, which comprises a first end and a plurality of second ends. The first end of the controllable switch is connected with a second end of the preset power source (the negative pole of the preset power source, i.e., the end K), and each second end thereof is connected with a negative pole of a corresponding light-emitting diode respectively.

When the light-emitting diode D1 needs to be activated, a connection between the end B1 and the end K would be turned on by the controllable switch. At this time, a voltage across the two ends of the light-emitting diode D1 reaches an operating voltage thereof, and thus the light-emitting diode D1 can emit light. Since the connections between each of the ends that are connected with the light-emitting diodes (i.e., the ends B1 to Bn) and the end K can be turned on or turned off by the controllable switch separately, each light-emitting diode can be activated or deactivated by the controllable switch separately as well. That is, one light-emitting diode or a plurality of light-emitting diodes can be activated or deactivated by the controllable switch at the same time.

Of course, according to other embodiments of the present disclosure, the control circuit can also be arranged between the light-emitting units and the positive pole of the preset power source. The first end of each light-emitting unit is connected with the control circuit, and the second end thereof is connected with the negative pole of the preset power source. The present disclosure is not limited by this.

Compared with the light source circuit of the backlight module in the prior art, in the light source circuit according to the present embodiment, the light-emitting units can be controlled separately. In this case, when it is not necessary to activate all light-emitting units according to actual needs of the liquid crystal display device, the light-emitting units which are necessary can be activated by the control circuit, while the light-emitting units which are not necessary can be deactivated by the control circuit. Since it is not necessary to activate all light-emitting units, the power consumption of the backlight module can be reduced effectively (for example, compared with the light source circuit in the prior art, the power consumption of the light source circuit provided by the present embodiment can be reduced by 40 percent), and thus the life time of the electric devices (such as mobile phones) can be prolonged.

In addition, in the light source circuit according to the present embodiment, the brightness of the light source can be regulated. Specifically, according to the present embodiment, the time period during which the light-emitting diode is activated or deactivated can be regulated by the controllable switch through regulating the duty ratio of the control signal. During a certain time period, the longer the time during which the light-emitting diode is activated is, the brighter the light source looks; on the contrary, during a certain time period, the shorter the time during which the light-emitting diode is activated is, the darker the light source looks. In this manner, the brightness of the light source can be regulated.

It should be noted that, according to other embodiments of the present disclosure, the light-emitting units and/or the control circuit can also be realized with other reasonable forms of circuit, and the present disclosure is not limited by this. For example, according to one embodiment of the present disclosure, the control circuit can be realized with Field Programmable Gate Array (FPGA) circuit. The FPGA circuit enables the switching circuit to have a higher response speed, so that the light-emitting units can be controlled by the control circuit in a timelier and more accurate manner.

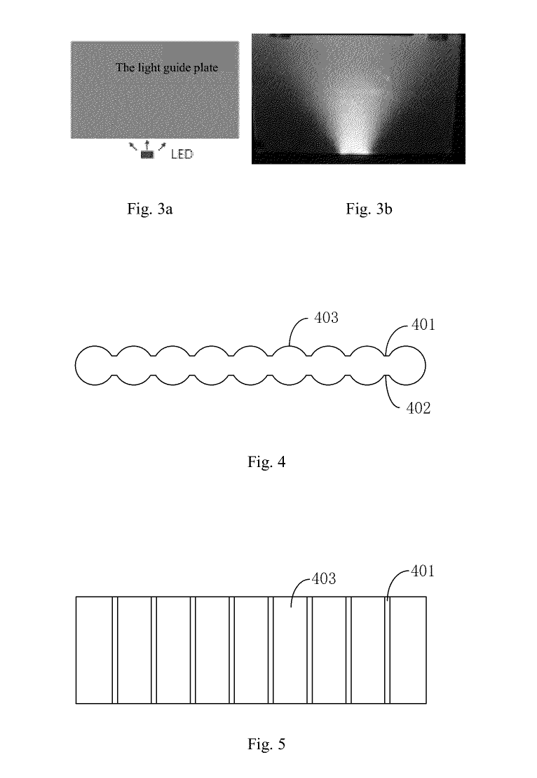

FIG. 3a and FIG. 3b schematically show a structure of a light source circuit in the prior art and a light path in a light guide plate in the prior art respectively. As shown in FIG. 3a, in the light source circuit in the prior art, a side light source is used. That is, the Light-Emitting Diode (LED), serving as the light source, is arranged on a lateral surface of the light guide plate. When the LED is activated, the light emitted by the LED enters into the light guide plate from the lateral surface thereof. The light guide plate in the prior art has a flat structure. As shown by the light path in the light guide plate in FIG. 3b, the light that enters into the light guide plate presents a divergent state, which shows that the light guide plate in the prior art cannot converge the light entered therein effectively, and thus the crosstalk phenomena of the light in adjacent regions of the light guide plate would occur easily.

In order to solve the aforesaid technical problem, the present embodiment further provides a light guide plate which can play the role of converging light effectively. FIG. 4 and FIG. 5 are a front view and a top view of the light guide plate respectively according to the present embodiment. As shown in FIG. 4 and FIG. 5, the light guide plate provided by the present embodiment comprises a first surface 401 and a second surface 402 in parallel with each other. The first surface 401 and the second surface 402 are provided with cylindrical protrusions that are parallel with one another, and the adjacent cylindrical protrusions are separated by a pre-determined distance.

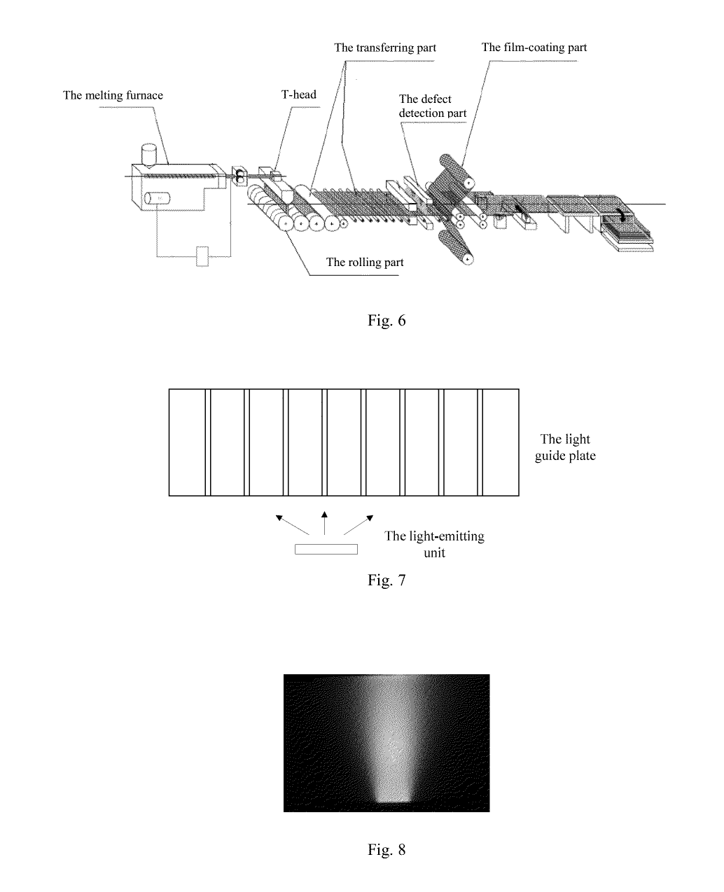

FIG. 6 schematically shows a device for manufacturing the light guide plate as shown in FIG. 4 and FIG. 5 according to the present embodiment.

According to the present embodiment, the light guide plate is made of engineering plastic. During manufacturing process, the engineering plastic is firstly melted into liquid state by a melting furnace, and then the engineering plastic in liquid state is transferred to a rolling part through a T-head. There is a certain distance between the T-head and the rolling part. The engineering plastic in liquid state, after being output by the T-head, is cooled gradually during dropping process. The engineering plastic is not cooled completely when reaching the rolling part, and thus the rolling can be performed conveniently.

According to the present embodiment, the rolling part of the device for manufacturing the light guide plate comprises a first roller and a second roller which rotate in cooperation with each other. Since the cylindrical protrusions need to be formed on the first surface and the second surface of the light guide plate, according to the present embodiment, the first roller and the second roller are both provided with protrusions. The engineering plastic, which is transferred from the T-head and is not cooled completely, can be rolled by the first roller and the second roller, so that the structure of the light guide plate as shown in FIG. 4 and FIG. 5 can be formed.

According to different embodiments of the present disclosure, the protrusions of the roller can be a plurality of circumferential protrusions arranged on a surface of a rolling axle, or can be a plurality of axial cylindrical protrusions arranged on the surface of the rolling axle. According to the present embodiment, the protrusions that are arranged on the first roller and the second roller are circumferential protrusions. This is because, when the engineering plastic is rolled by the roller with circumferential protrusions, a closed space would not be formed between the protrusions and the rolling axle, so that the air in the engineering plastic can be extruded effectively. In this case, the light guide plate rolled therein can have a more uniform structure, the impurities thereof are much less, so that the desirable light-guiding performance of the light guide plate can be guaranteed.

The engineering plastic, after being rolled by the rolling part, is transferred to a transferring part, so that the transferring part can transfer the light guide plate that comes from the rolling part to the following parts of the production line. Since the light guide plate that comes from the rolling part is not cooled completely, the process during which the light guide plate is transferred on the transferring part is the process during which the engineering plastic is cooled. In order to guarantee that the light guide plate is not damaged during this process, according to the present embodiment, the transferring part consists of a plurality of elastic wheels that are arranged side by side with one another so as to support and transfer the light guide plate that comes from the rolling part.

During the process of the light guide plate rolled therein being transferred on the transferring part, a defect detection part of the device would perform defect detection on the light guide plate, so that the structural integrity and the reliability of the light guide plate can be ensured. In addition, since the light guide plate manufactured therein has cylindrical protrusions, dust would accumulate easily on the surface among the cylindrical protrusions. Therefore, according to the present embodiment, the device for manufacturing the light guide plate, after performing defect detection on the light guide plate, can coat the light guide plate with films, so that the upper surface and the lower surface of the light guide plate are coated with protection films respectively. The protection films not only can effectively guarantee the light guide plate to be clean and dustless, but also can protect the surfaces of the light guide plate from being damaged. According to the present embodiment, the protection films that are coated on the light guide plate are adhesive films. Of course, according to other embodiments of the present disclosure, the light guide plate can also be coated with films of other reasonable forms.

At last, the light guide plate, after being coated with films, is cut, so that the light guide plate with required size can be obtained.

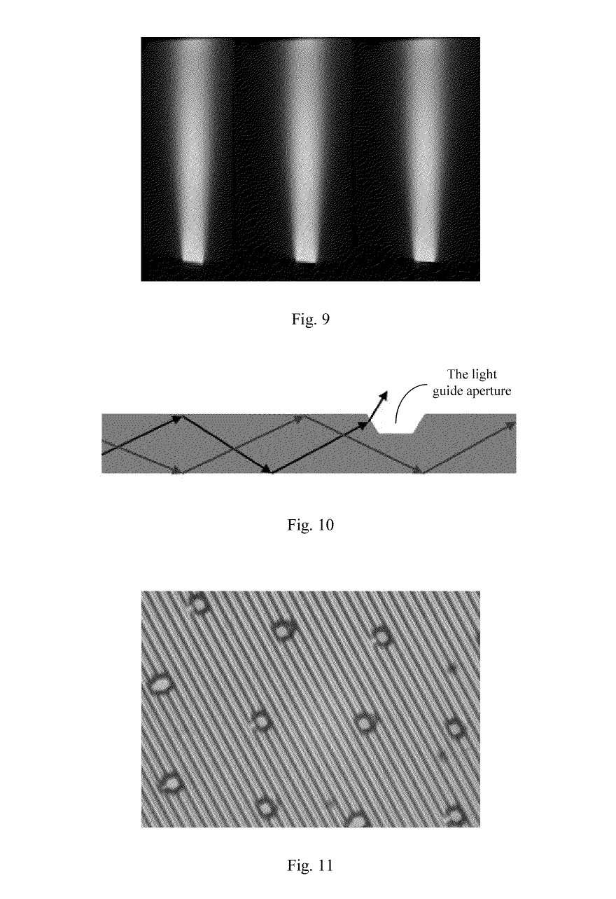

In order to present the light converging effect of the light guide plate as shown in FIG. 4 and FIG. 5 more clearly, according to the present disclosure, the light-emitting units are arranged on a lateral surface of the light guide plate as the manner shown in FIG. 7 and are turned on, so that the light-emitting units are in a working state. FIG. 8 and FIG. 9 schematically show a light path in the light guide plate when one light-emitting unit is activated and a light path in the light guide plate when multiple light-emitting units are activated respectively.

As shown in FIG. 8 and FIG. 9, according to the present embodiment, the cylindrical protrusions that are arranged on the surface of the light guide plate enable the light to be in a relatively convergent state when transmitting in the light guide plate. Therefore, compared with the light guide plate in the prior art, the light guide plate provided by the present embodiment has a better light converging effect. Thus, the crosstalk of the light in the light guide plate can be reduced significantly.

Since one of the roles played by the light guide plate is converting the side light source into the surface light source, the light inside the light guide plate should exit from the surface thereof. However, the light transmits in a total reflection manner inside the light guide plate, and the total reflection structure of the light guide plate should be destroyed so that the light can exit from the surface of the light guide plate.

As shown in FIG. 10, according to the present embodiment, the cylindrical protrusions of the light guide plate are provided with light guide apertures, so that the total reflection structure of the light guide plate can be destroyed. In this case, part of the light inside the light guide plate can exit from the light guide apertures, and thus the side light source can be converted into the surface light source. According to the present embodiment, as shown in FIG. 11, the light guide apertures are arranged on the cylindrical protrusions on the first surface of the light guide plate, so that the light cannot exit from the second surface of the light guide plate. In this manner, the utilization rate of the light that is emitted by the light source circuit can be ensured, and thus the brightness of the backlight module can be improved.

The light-emitting units are arranged on the lateral surface of the light guide plate, and the light which enters into the light guide plate would exit from the light guide apertures. Therefore, the larger the distance between the light guide aperture and the light-emitting units is, the less light would exit therefrom. In the light guide plate provided by the present embodiment, the light guide apertures are arranged in a non-uniform manner in order to guarantee the uniformity of the light that exits from the surface of the light guide plate. Specifically, in each cylindrical protrusion that is provided with light guide apertures, a space between two adjacent light guide apertures that are arranged in the cylindrical protrusion becomes nearer (i.e., the light guide apertures are distributed in a denser manner) when a distance thereof from a first end of the cylindrical protrusion (i.e., the end near to the light-emitting units) gets farther.

The light that exits from the light guide apertures near to the light-emitting units is relatively more, but the light guide apertures are distributed in a sparse manner at this region. By contrast, the light that exits from the light guide apertures far from the light-emitting units is relatively less, but the light guide apertures are distributed in a dense manner at this region. In this manner, the light that exits from each region of the light guide plate can be kept balanced, and thus the uniformity of the light that exits from the surface of the light guide plate can be ensured.

It should be noted that, according to other embodiments of the present disclosure, the uniformity of the light that exits from the surface of the light guide plate can be ensured through other reasonable methods. The present disclosure is not limited by the aforesaid method.

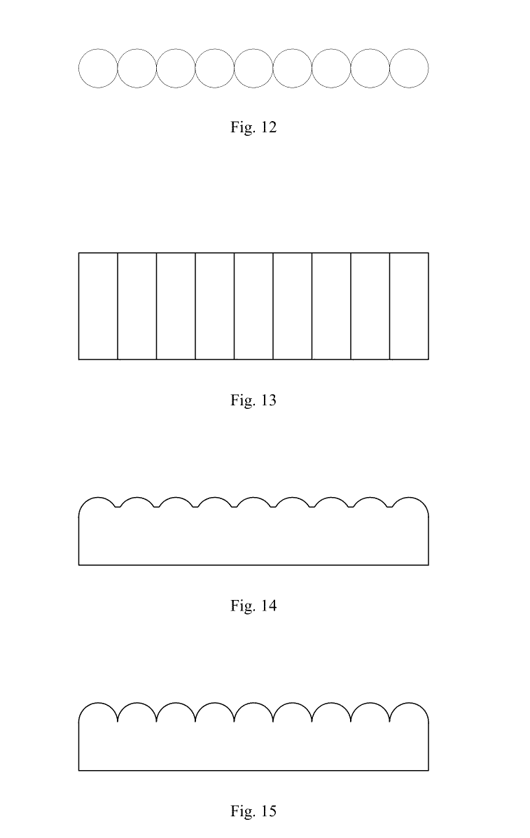

According to another embodiment of the present disclosure, the light guide plate can have a structure as shown in FIG. 12 and FIG. 13, which are a front view and a top view of the light guide plate respectively. It can be seen from FIG. 12 and FIG. 13 that, compared with the light guide plate as shown in FIG. 4 and FIG. 5, no distance is arranged between the adjacent cylindrical protrusions of the light guide plate, and the first surface and the second surface are in the same surface actually. The light guide plate can be considered to be constituted by a plurality of cylinders that are arranged side by side with one another.

According to a third embodiment of the present disclosure, the light guide plate can have a structure as shown in FIG. 14. It can be seen that, compared with the light guide plate as shown in FIG. 4, the light guide plate is only provided with cylindrical protrusions on the first surface, while the second surface still has a plane structure. According to the present embodiment, the light guide apertures are all arranged on the second surface. This is because, the second surface has a plane structure, and it is easy to form light guide apertures in the plane structure (for example, the light guide apertures can be formed through wet etching). However, it is hard to form light guide apertures in the cylindrical protrusions on the first surface (the light guide apertures are usually formed through laser etching), and the producing difficulty and cost of the light guide plate would be improved apparently. Of course, the light guide apertures can also be formed in the cylindrical protrusions on the first surface as long as the technology and cost thereof permit, and the present disclosure is not limited by this.

According to a fourth embodiment of the present disclosure, the light guide plate can have a structure as shown in FIG. 15. It can be seen in combination with FIG. 14 that, the light guide plate as shown in FIG. 15, in addition to the situation that no distance is arranged between the adjacent cylindrical protrusions of the light guide plate, has the same structure as the light guide plate as shown in FIG. 14, the details of which are no longer repeated here.

Compared with the light source circuit of the backlight module in the prior art, in the light source circuit of the backlight module according to the present disclosure, the light-emitting units can be controlled separately. In this case, when it is not necessary to activate all light-emitting units according to actual needs of the liquid crystal display device, the light-emitting units which are necessary can be activated by the control circuit, while the light-emitting units which are not necessary can be deactivated by the control circuit. Since it is not necessary to activate all light-emitting units, the power consumption of the backlight module can be reduced effectively, and thus the life time of the electric devices can be prolonged.

In addition, in the light source circuit according to the present disclosure, the brightness of the light source can also be regulated. Specifically, the time period during which the light-emitting diode is activated or deactivated can be regulated by the controllable switch through regulating the duty ratio of the control signal. During a certain time period, the longer the time during which the light-emitting diode is activated is, the brighter the light source looks; on the contrary, during a certain time period, the shorter the time during which the light-emitting diode is activated is, the darker the light source looks. In this manner, the brightness of the light source can be regulated.

According to the present disclosure, the surface of the light guide plate is provided with cylindrical protrusions that are parallel with one another, which enable the light to be in a relatively convergent state when transmitting in the light guide plate. Therefore, compared with the light guide plate in the prior art, the light guide plate provided by the present disclosure has a better light converging effect. Thus, the crosstalk of the light in the light guide plate can be reduced significantly.

In the light guide plate provided by the present disclosure, the light guide apertures are arranged in a non-uniform manner in order to guarantee the uniformity of the light that exits from the surface of the light guide plate. Specifically, in each cylindrical protrusion that is provided with light guide apertures, a space between two adjacent light guide apertures that are arranged in the cylindrical protrusion becomes nearer (i.e., the light guide apertures are distributed in a denser manner) when a distance between the light guide apertures and a first end of the cylindrical protrusion (i.e., the end near to the light-emitting units) gets farther.

The light that exits from the light guide apertures near to the light-emitting units is relatively more, but the light guide apertures are distributed in a sparse manner at this region. By contrast, the light that exits from the light guide apertures far from the light-emitting units is relatively less, but the light guide apertures are distributed in a dense manner at this region. In this manner, the light that exits from each region of the light guide plate can be kept balanced, and thus the uniformity of the light that exits from the surface of the light guide plate can be ensured.

It could be understood that, the embodiments disclosed herein are not limited by the specific structures, treatment steps or materials disclosed herein, but incorporate the equivalent substitutes of these features which are comprehensible to those skilled in the art. It could be also understood that, the terms used herein are used for describing the specific embodiments, not for limiting them.

The phrases “one embodiment” or “embodiments” referred to herein mean that the descriptions of specific features, structures and characteristics in combination with the embodiments are included in at least one embodiment of the present disclosure. Therefore, the phrases “one embodiment” or “embodiments” appeared in different parts of the whole description do not necessarily refer to the same embodiment.

For the purpose of convenience, a plurality of items, structural units, component units and/or materials used herein can be listed in a common list. However, the list shall be understood in a way that each element thereof represents an only and unique member. Therefore, when there is no other explanation, none of members of the list can be understood as an actual equivalent of other members in the same list only based on the fact that they appear in the same list. In addition, the embodiments and examples of the present disclosure can be explained with reference to the substitutes of each of the components. It could be understood that, the embodiments, examples and substitutes herein shall not be interpreted as the equivalents of one another, but shall be considered as separate and independent representatives of the present disclosure.

In addition, the features, structures and characteristics described herein can be combined with one another in any other suitable way in one embodiment or a plurality of embodiments. The specific details, such as lengths, widths and shapes, described herein are used for providing a comprehensive understanding of the embodiments of the present disclosure. However, it is understandable for those skilled in the art that, the present disclosure may be implemented in other ways different from the specific details specified herein, or may be implemented in other methods, components and materials. The structures, materials and operations known to all are not shown or described in the examples to avoid blurring various aspects of the present disclosure.

The embodiments are described hereinabove to interpret the principles of the present disclosure in one application or a plurality of applications. However, a person skilled in the art, without departing from the principles and thoughts of the present disclosure, can make various modifications to the forms, usages and details of the embodiments of the present disclosure without any creative work. Therefore, the protection scope of the present disclosure shall be determined by the claims.

1. A backlight module for liquid crystal display device, comprising a light source circuit and a light guide plate,
wherein said light source circuit comprises a control circuit, and a plurality of light-emitting units that are arranged on a lateral surface of said light guide plate and connected with said control circuit, each light-emitting unit being activated or deactivated by said control circuit; and
wherein said light guide plate is used for guiding light which enters from the lateral surface, so that the light exits from a front surface.

2. The backlight module according to claim 1, wherein a first end of each light-emitting unit is connected with a first end of a preset power source, and a second end thereof is connected with a corresponding end of said control circuit.

3. The backlight module according to claim 2, wherein each light-emitting unit comprises a light-emitting diode, a positive pole of said light-emitting diode being connected with the first end of the preset power source, and a negative pole thereof being connected with a corresponding end of said control circuit.

4. The backlight module according to claim 2, wherein said control circuit comprises a controllable switch, a first end of said controllable switch being connected with a second end of said preset power source, and each second end thereof being connected with a second end of a corresponding light-emitting unit respectively.

5. The backlight module according to claim 1, wherein said control circuit controls a time period during which said light-emitting unit is activated or deactivated through regulating a duty ratio of a control signal, so that brightness of said light-emitting unit is regulated.

6. The backlight module according to claim 1, wherein said light guide plate comprises a first surface and a second surface in parallel with each other, said first surface being provided with cylindrical protrusions that are parallel with one another, and said cylindrical protrusions or said second surface being provided with light guide apertures.

7. The backlight module according to claim 1, wherein said light guide plate comprises a first surface and a second surface in parallel with each other, said first surface and said second surface each being provided with cylindrical protrusions that are parallel with one another, and the cylindrical protrusions that are arranged on said first surface or said second surface being provided with light guide apertures.

8. The backlight module according to claim 6, wherein said light guide apertures are arranged along an axial direction of said cylindrical protrusions in a non-uniform manner.

9. The backlight module according to claim 7, wherein said light guide apertures are arranged along an axial direction of said cylindrical protrusions in a non-uniform manner.

10. The backlight module according to claim 8, wherein a space between two adjacent light guide apertures that are arranged in one cylindrical protrusion becomes nearer when a distance thereof from a first end of said cylindrical protrusion gets farther.

11. A liquid crystal display device, comprising a backlight module for the liquid crystal display device, said backlight module comprising a light source circuit and a light guide plate,
wherein said light source circuit comprises a control circuit and a plurality of light-emitting units, the light-emitting units are arranged on a lateral surface of said light guide plate and connected with said control circuit, each light-emitting unit being activated or deactivated by said control circuit; and
wherein said light guide plate is used for guiding light which enters from the lateral surface, so that the light exits from a front surface.

12. The liquid crystal display device according to claim 11, wherein a first end of each light-emitting unit is connected with a first end of a preset power source, and a second end thereof is connected with a corresponding end of said control circuit.

13. The liquid crystal display device according to claim 12, wherein each light-emitting unit comprises a light-emitting diode, a positive pole of said light-emitting diode being connected with the first end of the preset power source, and a negative pole thereof being connected with a corresponding end of said control circuit.

14. The liquid crystal display device according to claim 12, wherein said control circuit comprises a controllable switch, a first end of said controllable switch being connected with a second end of said preset power source, and each second end thereof being connected with a second end of a corresponding light-emitting unit respectively.

15. The liquid crystal display device according to claim 11, wherein said control circuit controls a time period during which said light-emitting unit is activated or deactivated through regulating a duty ratio of a control signal, so that brightness of said light-emitting unit is regulated.

16. The liquid crystal display device according to claim 11, wherein said light guide plate comprises a first surface and a second surface in parallel with each other, said first surface being provided with cylindrical protrusions that are parallel with one another, and said cylindrical protrusions or said second surface being provided with light guide apertures.

17. The liquid crystal display device according to claim 11, wherein said light guide plate comprises a first surface and a second surface in parallel with each other, said first surface and said second surface each being provided with cylindrical protrusions that are parallel with one another, and the cylindrical protrusions that are arranged on said first surface or said second surface being provided with light guide apertures.

18. The liquid crystal display device according to claim 16, wherein said light guide apertures are arranged along an axial direction of said cylindrical protrusions in a non-uniform manner.

19. The liquid crystal display device according to claim 17, wherein said light guide apertures are arranged along an axial direction of said cylindrical protrusions in a non-uniform manner.

20. The liquid crystal display device according to claim 18, wherein a space between two adjacent light guide apertures that are arranged in one cylindrical protrusion becomes nearer when a distance thereof from a first end of said cylindrical protrusion gets farther.
